(19) United States
(12) Patent Application Publication
(10) Pub. No.: US 2005/0170258 A1
(43) Pub. Date: Aug. 4, 2005

(54) Nonaqueous electrolyte battery

(75) Inventor: Kazuyuki Kawakami, Naruto-shi (JP)

Correspondence Address: NIXON & VANDERHYE, PC, 901 NORTH GLEBE ROAD, 11TH FLOOR, ARLINGTON, VA, 22203, US

(73) Assignee: SANYO ELECTRIC CO., LTD., Osaka (JP)

(21) Appl. No.: 11/019,644

(22) Filed: Dec. 23, 2004

(30) Foreign Application Priority Data
Dec. 24, 2003 (JP) 2003-427108

(51) Int. Cl. H01M 10/40; H01M 4/50; H01M 4/52

(52) U.S. Cl. 429/330; 429/231.3; 429/231.1; 429/224

(57) ABSTRACT

The nonaqueous electrolyte used in the nonaqueous electrolyte battery of the invention is characterized in that it contains vinylene carbonate (VC) and lithium borofluoride (LiBF₄) and further contains at least one derivative selected from among cycloalkylbenzene derivatives or from among alkylbenzene derivatives having a quaternary carbon atom directly bound to the benzene ring and having no primary or secondary alkyl group directly bound to the benzene ring. The use of such nonaqueous electrolyte makes the storage characteristics of the nonaqueous electrolyte battery at high temperature improve remarkably even when the content of LiBF₄ is reduced, while preventing diminution of battery capacity at the same time.

### FIELD OF THE INVENTION

This invention relates to a nonaqueous electrolyte battery comprising a positive electrode for occluding and releasing lithium ions, a negative electrode for occluding and releasing lithium ions, a separator separating the positive electrode and negative electrode from each other, and a nonaqueous electrolyte produced from the dissolution of a solute comprising lithium salt in a nonaqueous solvent.

### BACKGROUND OF THE INVENTION

Nonaqueous electrolyte batteries, typically lithium ion batteries which have high energy density and capacity are now widely used as driving power sources for mobile information terminals such as cellular phones, notebook personal computers, and PDAs (personal digital assistants), particularly because of their small size and light weight. Nonaqueous electrolyte batteries of this type are generally constituted by using a positive electrode comprising a lithium-containing transition metal oxide, such as LiCoO₂, LiNiO₂, LiMn₂O₄ or LiFeO₂, a negative electrode comprising carbon material, such as graphite, and a nonaqueous electrolyte produced by dissolving a solute comprising lithium salt in a nonaqueous solvent.

Meanwhile, in such nonaqueous electrolyte batteries, the organic solvent, which is a constituent of the electrolyte, is involved in and undergoes side reactions on the surface of the material serving as the negative electrode active material, and those side reactions adversely affect battery characteristics. Therefore, it is important to form a coating on the negative electrode surface to prevent the negative electrode from directly reacting with the organic solvent and to control the state of formation and the properties of such coating. The technology involved in controlling such negative electrode surface coating (SEI: solid electrolyte interface), which is generally known in the art, comprises the addition of a special additive to the electrolyte. Such known additive would typically be vinylene carbonate (VC) as disclosed in Japanese Patent Laid-Open No. H08-45545. This vinylene carbonate is added to an electrolyte produced by dissolving a solute comprising lithium salt in a nonaqueous solvent.

On the other hand, in the case of nonaqueous electrolyte batteries in which spinel type lithium manganese oxide is used as the positive electrode active material and LiPF₆ as solute in the nonaqueous electrolyte, the occurrence of a slight amount of H₂O causes gradual decomposition of LiPF₆ to generate hydrogen fluoride (HF), which in turn causes elution of Mn which markedly causes the deterioration of characteristics of the positive electrode active material. Therefore, in Japanese Patent Laid-Open No. 2000-12025, it has been proposed that LiBF₄ be used as solute in the nonaqueous electrolyte in lieu of LiPF₆.

However, in the case of nonaqueous electrolyte batteries in which LiBF₄ is used as solute, the storage characteristics of the nonaqueous electrolyte cannot be said to be satisfactory at high temperature owing to the fact that gas mainly composed of carbon dioxide is generated from the negative electrode during storage at high temperature although HF concentration is maintained at low levels. Accordingly, in Japanese Patent Laid-Open No. 2002-231307, it has been proposed that HF concentration in the nonaqueous electrolyte containing LiBF₄ as solute be controlled within the range of 30 ppm to 1,000 ppm to achieve improvement of storage characteristics at high temperature.

The electrolyte containing vinylene carbonate (VC) used as an additive in nonaqueous electrolyte batteries, as taught in the above-cited Japanese Patent Laid-Open No. H08-45545, causes the formation of SEI on the negative electrode surface aimed at inhibiting side reactions on the negative electrode and improving cycle characteristics. However, because the film of SEI coating is firm, Li ions settle in metal form, on the negative electrode surface during the initial stage of charging, resulting in reduced charging efficiency as well as initial capacity of the battery. Moreover, the use of VC-added electrolyte in nonaqueous electrolyte batteries has not yielded marked improvement in high temperature cycle characteristics and even causes the batteries to expand during storage at high temperature. This is presumably due to the fact that when such nonaqueous electrolyte batteries are allowed to stand at high temperatures, VC is oxidized and decomposes to generate carbon dioxide.

Further, as indicated in the above-cited Japanese Patent Laid-Open No. 2000-12025 and Japanese Patent Laid-Open No. 2002-231307, large amounts of LiBF₄ must be used as a substitute for LiPF₆, which is generally in wide use. In this case, a thick film coating is formed on the negative electrode surface and, therefore, metallic lithium precipitates on the negative electrode surface in the first charging immediately after the batteries are completed, with the result that the charging/discharging efficiency lowers and the battery capacity decreases. Thus, it is necessary to attain a satisfactory improvement in storage characteristics and concurrently avoid decrease in capacity if LiBF₄ is to be used in lieu of LiPF₆.

While a thick film coating will not form on the negative electrode surface if the amount of LiBF₄ is decreased, thereby preventing decrease in battery capacity, the beneficial effect achieved by improving storage characteristics of the battery during high temperature in the process is however reduced, if not negated.

### SUMMARY OF THE INVENTION

The present invention is therefore directed at solving the abovementioned problems, by providing a nonaqueous electrolyte battery whose capacity can be maintained and prevented from decreasing during storage at high temperatures.

To accomplish the above object, the nonaqueous electrolyte to be used in the nonaqueous electrolyte battery of the invention is characterized in that it contains vinylene carbonate (VC) and lithium borofluoride (or lithium fluoroborate; LiBF₄) and, further, at least one derivative selected from among cycloalkylbenzene derivatives or from among alkylbenzene derivatives having a quaternary carbon atom directly bound to the benzene ring and having no primary or secondary alkyl group directly bound to the benzene ring.

It has been found that when a nonaqueous electrolyte containing VC and LiBF₄ is caused to further contain at least one derivative selected from among cycloalkylbenzene derivatives or from among alkylbenzene derivatives having a quaternary carbon atom directly bound to the benzene ring and having no primary or secondary alkyl group directly bound to the benzene ring, it becomes possible to attain improvement of storage characteristics at high temperatures and concurrently prevent the diminution of battery capacity even if the content of LiBF₄ is reduced.

The reasons therefor are not clear but presumably are as follows. It is known that each of these additives reacts with the positive electrode active material to form a film coating thereon. However, when these additives are used in combination, the film coating formed probably differs from that which is formed when these additives are used singly and is suitable for protecting the positive electrode active material from reacting with the nonaqueous electrolyte during storage at high temperature.

In that case, the content of vinylene carbonate (VC) preferably must be not lower than 1% by mass but not higher than 3% by mass, while the content of lithium borofluoride (LiBF₄) must not be lower than 0.05% by mass but not higher than 0.5% by mass, and the content of the above-defined derivative must not be lower than 0.5% by mass but not higher than 3% by mass, relative to the mass of the nonaqueous electrolyte. Further, the content of lithium borofluoride (LiBF₄) preferably should not be lower than 0.1% by mass but not higher than 0.2% by mass relative to the mass of the nonaqueous electrolyte.

The cycloalkylbenzene derivative would preferably be cyclohexylbenzene or cyclopentylbenzene. The alkylbenzene derivative having a quaternary carbon atom directly bound to the benzene ring and having no primary or secondary alkyl group directly bound to the benzene ring should preferably be tert-amylbenzene, tert-butylbenzene or tert-hexylbenzene. The positive electrode should contain a mixed positive electrode active material comprising lithium cobalt oxide and spinel type lithium manganese oxide.

### BRIEF DESCRIPTION OF THE DRAWINGS

FIG. 1 schematically illustrates, by section, a nonaqueous electrolyte battery of the invention. Thus, FIG. 1A is a cross section, along the line B-B in FIG. 1B, of such battery, and FIG. 1B a cross section, along the line A-A in FIG. 1A, of such battery.

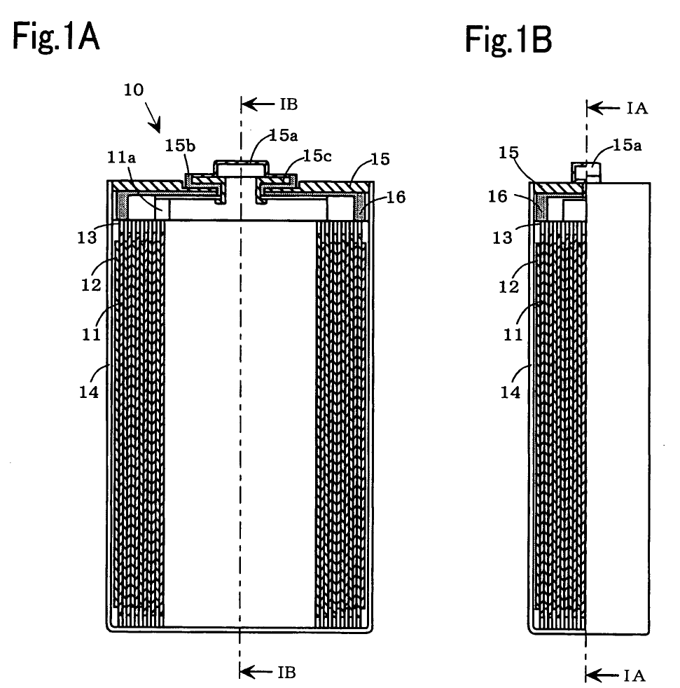

### DETAILED DESCRIPTION OF THE INVENTION

The typical modes of embodiment of the invention shall be described hereafter. These modes of embodiment, however, are by no means restrictive of the scope of the invention as various modifications and variations may be made without deviating from the scope of the invention.

1. Negative Electrode Preparation

First, a scaly natural graphite powder (e.g. a powder with an average particle diameter of 20 μm, the (002) plane spacing (d₀₀₂) thereof being 3.358 Å and the crystallite size in the c axial direction (Lc) being 1,000 Å), and a styrene-butadiene rubber (SBR) dispersion (solid matter content 48%) to serve as binder, were dispersed in water. Then, carboxymethylcellulose (CMC) was added as a thickener to produce a negative electrode slurry, in which the solid matter mass ratio, namely graphite:SBR:CMC, was adjusted in order that such ratio after drying would approximately be 100:3:2.

Negative electrode active material layers were then formed by applying the negative electrode slurry to both sides of a negative electrode current collector made of copper foil (e.g., 8 μm in thickness) by means of the doctor blade method. After drying, the coated matter was rolled to attain a desired packing density and then cut to a desired shape, followed by 2 hours of drying at 110° C. in a vacuum to yield a negative electrode 11. After drying, the mass of the negative electrode active material layers on both sides at the respective sites where the mass thereof is constant is 200 g/m² (100 g/m² on each side; excluding the mass of the collector), and the active material packing density is 1.5 g/cm³. A negative electrode lead 11a was then formed by extension from one end of the negative electrode 11.

As binder, a styrene-butadiene copolymer, or a polymer of methyl (meth)acrylate, ethyl (meth)acrylate, butyl (meth)acrylate, (meth)acrylonitrile, hydroxyethyl (meth)acrylate or such polymer similar to ethylenically unsaturated carboxylic acid ester may also be used in lieu of styrene-butadiene rubber (SBR). Alternatively, a polymer of acrylic acid, methacrylic acid, itaconic acid, fumaric acid, maleic acid or that which is similar to ethylenically unsaturated carboxylic acid may be used. As thickener, methylcellulose, hydroxymethylcellulose, ethylcellulose, polyvinyl alcohol, polyacrylic acid (salt), oxidized starch, phosphorylated starch, casein or the like may be used in lieu of carboxymethylcellulose (CMC).

2. Positive Electrode Preparation

The positive electrode mixture was prepared by combining lithium cobalt oxide (LiCoO₂) powder with an average particle diameter of 5 μm, as positive electrode active material, and an artificial graphite powder as conductor, to form a mass ratio of 9:1. A binder solution consisting of polyvinylidene fluoride (PVdF) dissolved in N-methyl-2-pyrrolidone (NMP) to a concentration of 5% by mass was then added to this positive electrode mixture. The mixture:binder mixing ratio is 95:5 by mass on the solid matter basis. The resulting mixture was then used as the positive electrode slurry. In lieu of the lithium cobalt oxide (LiCoO₂) powder, positive electrode slurries may be prepared in the same manner using other lithium-containing transition metal double oxides such as lithium manganese oxide (LiMn₂O₄) or lithium nickel oxide (LiNiO₂), or an oxide resulting from the substitution of the hetero atom such as Al, Ti, Mg or Zr for a transition atom present in those oxides or such oxide resulting from the addition of such an element.

Positive electrode mixture layers are then formed by applying the positive electrode slurry obtained to both sides of an aluminum foil (e.g., 15 μm in thickness) to serve as the negative electrode current collector by means of the doctor blade method. After drying, the coated matter was rolled to attain a desired packing density, then cut to a desired shape and dried at 150° C. in a vacuum for 2 hours to produce a positive electrode 12. After drying, the mass of the of the positive electrode mixture layers on both sides at the respective sites where the mass thereof is constant is 500 g/m² (250 g/m² on each side; excluding the mass of the collector), and the active material packing density is 3.5 g/cm³. A positive electrode lead was then formed by extension from one end of the positive electrode 12.

3. Preparation of Nonaqueous Electrolytes

(1) Nonaqueous Electrolytes in which LiBF₄, VC and CHB are used as Additives

An additive-free nonaqueous electrolyte x1 was prepared by dissolving 1 mol/liter of LiPF₆ in a mixed solvent composed of equal volumes of ethylene carbonate (EC) and dimethyl carbonate (DMC) (EC:DMC=50:50). Then, nonaqueous electrolytes a0 to a9 were prepared by adding, to the thus-obtained nonaqueous electrolyte x1, vinylene carbonate (VC; hereinafter referred to “VC”) and cyclohexylbenzene (hereinafter, “CHB”) as a cycloalkylbenzene derivative in the amounts of 2.00% by mass and 1.00% by mass, respectively, relative to the mass of the nonaqueous electrolyte, together with LiBF₄, as additives. The nonaqueous electrolytes in which the levels of addition of LiBF₄ were 0.03% by mass, 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes a1, a2, a3, a4, a5, a6, a7, a8, and a9, respectively. The LiBF4-free nonaqueous electrolyte was designated as nonaqueous electrolyte a0.

(2) Nonaqueous Electrolytes in which LiBF₄, VC and TAB were used as Additives

Nonaqueous electrolytes b0 to b9 were prepared by adding, to the above-obtained nonaqueous electrolyte x1, VC and tert-amylbenzene (hereinafter, “TAB”) as an alkylbenzene derivative having a quaternary carbon atom directly bound to the benzene ring and having no primary or secondary alkyl group directly bound to the benzene ring in the amounts of 2.00% by mass and 1.00% by mass, respectively, relative to the mass of the nonaqueous electrolyte, together with LiBF₄, as additives. The nonaqueous electrolytes in which the levels of addition of LiBF₄ were 0.03% by mass, 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes b1, b2, b3, b4, b5, b6, b7, b8, and b9, respectively. The LiBF₄-free nonaqueous electrolyte was designated as nonaqueous electrolyte b0.

(3) Nonaqueous Electrolytes in which LiBF₄, VC and TBB were used as Additives

Nonaqueous electrolytes c0 to c9 were prepared by adding, to the above-obtained nonaqueous electrolyte x1, VC and tert-butylbenzene (hereinafter, “TBB”) as an alkylbenzene derivative having a quaternary carbon atom directly bound to the benzene ring and having no primary or secondary alkyl group directly bound to the benzene ring in the amounts of 2.00% by mass and 1.00% by mass, respectively, relative to the mass of the nonaqueous electrolyte, together with LiBF₄, as additives. The nonaqueous electrolytes in which the levels of addition of LiBF₄ were 0.03% by mass, 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes c1, c2, c3, c4, c5, c6, c7, c8, and c9, respectively. The LiBF₄-free nonaqueous electrolyte was designated as nonaqueous electrolyte c0.

(4) Nonaqueous Electrolytes in which LiBF₄, VC, CHB and TAB were used as Additives

Nonaqueous electrolytes d0 to d9 were prepared by adding, to the above-obtained nonaqueous electrolyte x1, VC, CHB and TAB in the amounts of 2.060% by mass, 1.00% by mass and 1.50% by mass, respectively, relative to the mass of the nonaqueous electrolyte, together with LiBF₄, as additives. The nonaqueous electrolytes in which the levels of addition of LiBF₄ were 0.03% by mass, 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes d1, d2, d3, d4, d5, d6, d7, d8, and d9, respectively. The LiBF4-free nonaqueous electrolyte was designated as nonaqueous electrolyte d0.

(5) Nonaqueous Electrolytes in which LiBF₄ was used Solely as an Additive

Nonaqueous electrolytes e1 to e8 were prepared by adding LiBF₄ solely as an additive to the above-obtained nonaqueous electrolyte x1. The nonaqueous electrolytes in which the levels of addition of LiBF₄ were 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes e1, e2, e3, e4, e5, e6, e7, and e8, respectively. The LiBF₄-free nonaqueous electrolyte is similar to the nonaqueous electrolyte x1.

(6) Nonaqueous Electrolytes in which CHB was used Solely as an Additive

Nonaqueous electrolytes f1 to f8 were prepared by adding CHB solely as an additive to the above-obtained nonaqueous electrolyte x1. The nonaqueous electrolytes in which the levels of addition of CHB were 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes f1, f2, f3, f4, f5, f6, f7, and f8, respectively. The CHB-free nonaqueous electrolyte is similar to the nonaqueous electrolyte x1.

(7) Nonaqueous Electrolytes in which TAB Alone was used Solely as an Additive

Nonaqueous electrolytes g1 to g8 were prepared by adding TAB solely as an additive to the above-obtained nonaqueous electrolyte x1. The nonaqueous electrolytes in which the levels of addition of TAB were 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes g1, g2, g3, g4, g5, g6, g7, and g8, respectively. The LiBF₄-free nonaqueous electrolyte is similar to the nonaqueous electrolyte x1.

(8) Nonaqueous Electrolytes in which TBB Solely was used as an Additive

Nonaqueous electrolytes h1 to h8 were prepared by adding TBB solely as an additive to the above-obtained nonaqueous electrolyte x1. The nonaqueous electrolytes in which the levels of addition of TBB were 0.05% by mass, 0.07% by mass, 0.10% by mass, 0.20% by mass, 0.30% by mass, 0.50% by mass, 1.00% by mass, and 1.20% by mass, respectively, on the nonaqueous electrolyte mass basis, were designated as nonaqueous electrolytes h1, h2, h3, h4, h5, h6, h7, and h8, respectively. The TBB-free nonaqueous electrolyte is similar to the nonaqueous electrolyte x1.

As solvent in the nonaqueous electrolyte, ethylene carbonate (EC), propylene carbonate (PC), butylenes carbonate, vinylene carbonate, cyclopentanone, sulfolane, 3-methylsulfolane, 2,4-dimethylsulfolane, 3-methyl-1,3-oxazolidin-2-one, ,,-butyrolactone, dimethyl carbonate, diethyl carbonate, ethyl methyl carbonate, methyl propyl carbonate, butyl methyl carbonate, ethyl propyl carbonate, butyl ethyl carbonate, dipropyl carbonate, 1,2-dimethoxyethane, tetrahydrofuran, 2-methyltetrahydrofuran, 1,3-dioxolane, methyl acetate, ethyl acetate and the like may be used either singly or in the form of a binary mixture or ternary mixture in lieu of the mixed solvent composed of ethylene carbonate (EC) and dimethyl carbonate (DMC).

As solute in the nonaqueous electrolyte, LiCF₃SO₃, LiAsF₆, LiN(CF₃SO₂)₂, LiOSO₂(CF₂)₃CF₃, LiClO₄ or the like may also be used in lieu of LiPF₆.

4. Manufacture of Nonaqueous Electrolyte Batteries

The negative electrode 11 and positive electrode 12 prepared as described above were then placed on top of each other with micro porous polyethylene membranes interposed between them as separators 13, and the whole unit was thereafter spirally wound up. The spiral was then pressed and flattened to yield an electrode group, which was thereafter inserted into an enclosure can 14 (simultaneously serving as the positive electrode terminal) through the opening thereof. Then, a spacer 16 was disposed on top of the electrode group, and the negative electrode lead 11a extending from the negative electrode 11 of the electrode group was welded to the inside bottom of a terminal strip 15c disposed on a closing member 15. On the other hand, the positive electrode lead extending from the positive electrode sheet 12 of the electrode group was sandwiched between the enclosure can 14 and closing member 15, with the closing member 15 being disposed in the opening of the enclosure can 14. The circumferential wall of the opening of the enclosure can 14 and the closing member 15 were joined together by laser welding.

Thereafter, one of the electrolytes a0-a9, b0-b9, c0-c9, d0-d9, e1-e8, f1-f8, g1-g8 and h1-h8 prepared as described above was poured into each enclosure can 14 through a passage provided on the terminal strip 15c. Then, each negative electrode terminal 15a was welded to each terminal strip 15c for sealing. Thus were manufactured rectangular nonaqueous electrolyte batteries 10 (A0-A9, B0-B9, C0-C9, D0-D9, E1-E8, F1-F8, G1-G8, H1-H8, and X1) with a thickness of 5 mm, width of 30 mm and height of 48 mm, and a design capacity of 700 mAh. The closing member 15 of each battery was provided with a safety valve (not shown) so that the gas generated due to the increase in inside pressure of the battery may be released out of the battery.

Hereafter, the manufactured nonaqueous electrolyte batteries in which nonaqueous electrolytes a0-a9 were designated as batteries A0-A9, while those using the nonaqueous electrolytes b0-b9 were designated as batteries B0-B9, and those using the nonaqueous electrolytes c0-c9 were designated as batteries C0-C9. Further, those using the nonaqueous electrolytes d0-d9 were designated as batteries D0-D9, while those using the nonaqueous electrolytes e1-e8 were designated as batteries E1-E8, and those using the nonaqueous electrolytes f1-f8 were designated as batteries E1-E8. Further, those using the nonaqueous electrolytes g1-g8 were designated as batteries G1-G8, and those using the nonaqueous electrolytes h1-h8 were designated as batteries H1-H8, respectively. The nonaqueous electrolyte battery using the nonaqueous electrolyte x1 was designated as battery X1.

5. Battery Testing

(1) Initial Capacity Measurement

Batteries A0-A9, B0-B9, C0-C9, D0-D9, E1-E8, F1-F8, G1-G8, H1-H8, and X1 were charged at room temperature (about 25° C.) at a constant charging current of 700 mA (1 It) until the battery voltage reached 4.2 V and then at a constant voltage of 4.2 V until the current value reached 10 mA. Then, the batteries were discharged at a discharge current of 700 mA (1 It) until the battery voltage reached 2.75 V. Thereafter, the discharge capacity of each battery was measured based on the duration of discharge, and initial discharge capacity was determined. Then, the initial discharge capacities of the batteries A0, B0, C0and D0were respectively determined to be 100, while the initial discharge capacities of the batteries A1-A9, B1-B9, C1-C9 and D1-D9 are expressed in terms of relative values, yielding the results shown in Table 1 below. The initial discharge capacity of the battery X1 was likewise determined to be 100. The initial discharge capacities of the other batteries E1-E8, F1-F8, G1-G8 and H1-H8 are also expressed in terms of relative values, yielding the results shown in Table 2 below.

(2) High-Temperature Storage Characteristics Testing

The initial discharge capacity (Z1) of each of the batteries A0-A9, B0-B9, C0-C9, D0-D9, E1-E8, F1-F8, G1-G8, H1-H8, and X1 was thus determined by charging and discharging them in the above manner. Each battery was charged at room temperature (about 25° C.) at a constant charging current of 700 mA (1 It) until the battery voltage reached 4.2 V and then at a constant voltage of 4.2 V until the current value reached 10 mA. Thereafter, the battery was stored in a constant-temperature bath at 60° C. for 20 days.

At the end of the storage period, the batteries were discharged at room temperature (about 25° C.) at a discharge current of 700 mA (1 It) until the battery voltage reached 2.75 V and then, charging was carried out at a constant charging current of 700 mA (1 It) until the battery voltage reached 4.2 V and then at a constant voltage of 4.2 V until the current value reached 10 mA. Thereafter, the batteries were discharged at a discharge current of 700 mA (1 It) until the battery voltage reached 2.75 V, and the discharge capacity (Z2) of each battery after storage at the elevated temperature was determined based on the duration of discharge. Then, the capacity retention percentage (high temperature capacity retention percentage) of each battery after 20 days of storage at the elevated temperature (60° C.) was determined by calculating the ratio between the discharge capacity (Z2) after storage at the elevated temperature and the initial discharge capacity (Z1) determined previously ((Z2/Z1)×100%). The results obtained are shown in Tables 1 and 2 below.

TABLE 1

| | | | | | | | Capacity |
|---|---|---|---|---|---|---|---|
| | Additives and Levels of | | | | | Relative | Retention |
| | Addition (% by mass) | | | | | Initial | (%) at high |
| Battery | LiBF₄ | VC | CHB | TAB | TBB | Capacity | temperature |
| A0 | 0 | 2.00 | 1.00 | 0 | 0 | 100 | 82 |
| A1 | 0.03 | 2.00 | 1.00 | 0 | 0 | 100 | 83 |
| A2 | 0.05 | 2.00 | 1.00 | 0 | 0 | 99 | 89 |
| A3 | 0.07 | 2.00 | 1.00 | 0 | 0 | 100 | 90 |
| A4 | 0.10 | 2.00 | 1.00 | 0 | 0 | 100 | 92 |
| A5 | 0.20 | 2.00 | 1.00 | 0 | 0 | 100 | 93 |
| A6 | 0.30 | 2.00 | 1.00 | 0 | 0 | 100 | 91 |
| A7 | 0.50 | 2.00 | 1.00 | 0 | 0 | 99 | 90 |
| A8 | 1.00 | 2.00 | 1.00 | 0 | 0 | 96 | 83 |
| A9 | 1.20 | 2.00 | 1.00 | 0 | 0 | 92 | 80 |
| B0 | 0 | 2.00 | 0 | 1.00 | 0 | 100 | 82 |
| B1 | 0.03 | 2.00 | 0 | 1.00 | 0 | 99 | 83 |
| B2 | 0.05 | 2.00 | 0 | 1.00 | 0 | 100 | 89 |
| B3 | 0.07 | 2.00 | 0 | 1.00 | 0 | 100 | 87 |
| B4 | 0.10 | 2.00 | 0 | 1.00 | 0 | 99 | 93 |
| B5 | 0.20 | 2.00 | 0 | 1.00 | 0 | 100 | 93 |
| B6 | 0.30 | 2.00 | 0 | 1.00 | 0 | 101 | 91 |
| B7 | 0.50 | 2.00 | 0 | 1.00 | 0 | 100 | 91 |
| B8 | 1.00 | 2.00 | 0 | 1.00 | 0 | 98 | 87 |
| B9 | 1.20 | 2.00 | 0 | 1.00 | 0 | 93 | 78 |
| C0 | 0 | 2.00 | 0 | 0 | 1.00 | 100 | 82 |
| C1 | 0.03 | 2.00 | 0 | 0 | 1.00 | 100 | 84 |
| C2 | 0.05 | 2.00 | 0 | 0 | 1.00 | 101 | 89 |
| C3 | 0.07 | 2.00 | 0 | 0 | 1.00 | 100 | 90 |
| C4 | 0.10 | 2.00 | 0 | 0 | 1.00 | 100 | 93 |
| C5 | 0.20 | 2.00 | 0 | 0 | 1.00 | 100 | 92 |
| C6 | 0.30 | 2.00 | 0 | 0 | 1.00 | 100 | 91 |
| C7 | 0.50 | 2.00 | 0 | 0 | 1.00 | 100 | 90 |
| C8 | 1.00 | 2.00 | 0 | 0 | 1.00 | 95 | 87 |
| C9 | 1.20 | 2.00 | 0 | 0 | 1.00 | 93 | 82 |
| D0 | 0 | 2.00 | 1.00 | 1.50 | 0 | 100 | 80 |
| D1 | 0.03 | 2.00 | 1.00 | 1.50 | 0 | 99 | 81 |
| D2 | 0.05 | 2.00 | 1.00 | 1.50 | 0 | 100 | 88 |
| D3 | 0.07 | 2.00 | 1.00 | 1.50 | 0 | 100 | 91 |
| D4 | 0.10 | 2.00 | 1.00 | 1.50 | 0 | 99 | 92 |
| D5 | 0.20 | 2.00 | 1.00 | 1.50 | 0 | 100 | 92 |
| D6 | 0.30 | 2.00 | 1.00 | 1.50 | 0 | 101 | 90 |
| D7 | 0.50 | 2.00 | 1.00 | 1.50 | 0 | 100 | 89 |
| D8 | 1.00 | 2.00 | 1.00 | 1.50 | 0 | 94 | 88 |
| D9 | 1.20 | 2.00 | 1.00 | 1.50 | 0 | 93 | 83 |

TABLE 2

| | | | | | | | Capacity |
|---|---|---|---|---|---|---|---|
| | Additives and Levels of | | | | | Relative | Retention (%) |
| | Addition (% by mass) | | | | | Initial | at high |
| Battery | LiBF₄ | VC | CHB | TAB | TBB | Capacity | temperature |
| X1 | 0 | 0 | 0 | 0 | 0 | 100 | 82 |
| E1 | 0.05 | 0 | 0 | 0 | 0 | 100 | 82 |
| E2 | 0.07 | 0 | 0 | 0 | 0 | 100 | 84 |
| E3 | 0.10 | 0 | 0 | 0 | 0 | 100 | 84 |
| E4 | 0.20 | 0 | 0 | 0 | 0 | 100 | 86 |
| E5 | 0.30 | 0 | 0 | 0 | 0 | 100 | 83 |
| E6 | 0.50 | 0 | 0 | 0 | 0 | 100 | 84 |
| E7 | 1.00 | 0 | 0 | 0 | 0 | 95 | 80 |
| E8 | 1.20 | 0 | 0 | 0 | 0 | 93 | 80 |
| F1 | 0 | 0 | 0.05 | 0 | 0 | 100 | 83 |
| F2 | 0 | 0 | 0.07 | 0 | 0 | 100 | 80 |
| F3 | 0 | 0 | 0.10 | 0 | 0 | 100 | 82 |
| F4 | 0 | 0 | 0.20 | 0 | 0 | 100 | 82 |
| F5 | 0 | 0 | 0.30 | 0 | 0 | 99 | 81 |
| F6 | 0 | 0 | 0.50 | 0 | 0 | 100 | 82 |
| F7 | 0 | 0 | 1.00 | 0 | 0 | 99 | 80 |
| F8 | 0 | 0 | 1.20 | 0 | 0 | 100 | 80 |
| G1 | 0 | 0 | 0 | 0.05 | 0 | 101 | 82 |
| G2 | 0 | 0 | 0 | 0.07 | 0 | 100 | 84 |
| G3 | 0 | 0 | 0 | 0.10 | 0 | 100 | 80 |
| G4 | 0 | 0 | 0 | 0.20 | 0 | 100 | 81 |
| G5 | 0 | 0 | 0 | 0.30 | 0 | 99 | 82 |
| G6 | 0 | 0 | 0 | 0.50 | 0 | 100 | 81 |
| G7 | 0 | 0 | 0 | 1.00 | 0 | 100 | 82 |
| G8 | 0 | 0 | 0 | 1.20 | 0 | 100 | 82 |
| H1 | 0 | 0 | 0 | 0 | 0.05 | 99 | 82 |
| H2 | 0 | 0 | 0 | 0 | 0.07 | 100 | 82 |
| H3 | 0 | 0 | 0 | 0 | 0.10 | 100 | 82 |
| H4 | 0 | 0 | 0 | 0 | 0.20 | 101 | 80 |
| H5 | 0 | 0 | 0 | 0 | 0.30 | 99 | 81 |
| H6 | 0 | 0 | 0 | 0 | 0.50 | 100 | 81 |
| H7 | 0 | 0 | 0 | 0 | 1.00 | 101 | 83 |
| H8 | 0 | 0 | 0 | 0 | 1.20 | 100 | 81 |

As may be gleaned from Table 2, the batteries E1-E8, F1-F8, G1-G8 and H1-H8 using nonaqueous electrolytes which were prepared with the addition of LiBF₄, CHB, TAB or TBB singly as an additive to the nonaqueous electrolyte x1 showed little improvement in capacity retention percentage (capacity retention percentage at high temperature) after 20 days of storage at the elevated temperature (60° C.) even if the levels of these additives were altered, as compared with the battery X1 using the nonaqueous electrolyte x1 without any additive.

On the other hand, as may be derived from Table 1, the batteries A1-A9 using nonaqueous electrolytes which were prepared with the addition of 2.00% by mass of VC and 1.00% by mass of cyclohexylbenzene (CHB) (a cycloalkylbenzene derivative) together with LiBF₄ as additives to the nonaqueous electrolyte x1, exhibited improvement in capacity retention percentage after 20 days of storage at the elevated temperature (60° C.) as a result of adjustment of the level of addition of LiBF₄. In these cases, the batteries A2 to A7 in which the level of addition of LiBF₄ was not lower than 0.05% by mass but not higher than 0.50% by mass showed improvement in capacity retention percentage after 20 days of storage at the elevated temperature (60° C.) while the improvement in capacity retention percentage with respect to the batteries A4 and A5 in which the level of addition of LiBF₄ was not less than 0.10% by mass but not higher than 0.20% by mass was even more remarkable.

Further, the batteries B1-B9 using nonaqueous electrolytes which were prepared with the addition of 2.00% by mass of VC and 1.00% by mass of tert-amylbenzene (TAB) (an alkylbenzene derivative having a quaternary carbon atom directly bound to the benzene ring and having no primary or secondary alkyl group directly bound to the benzene ring) together with LiBF₄ as additives to the nonaqueous electrolyte x1 likewise exhibited improvement in capacity retention percentage after 20 days of storage at the elevated temperature (60° C.) as a result of adjustment of the level of addition of LiBF₄. In these cases, too, the batteries B2 to B7 in which the level of addition of LiBF₄ was not lower than 0.05% by mass but not higher than 0.50% by mass showed improvement in capacity retention percentage after 20 days of storage at the elevated temperature (60° C.) while the improvement in capacity retention percentage of the batteries B4 and B5 in which the level of addition of LiBF₄ was not less than 0.10% by mass but not higher than 0.20% by mass was far more remarkable.

The batteries C1-C9 using nonaqueous electrolytes which were prepared with the addition of 2.00% by mass of VC and 1.00% by mass of tert-butylbenzene (TBB) (an alkylbenzene derivative having a quaternary carbon atom directly bound to the benzene ring and having no primary or secondary alkyl group directly bound to the benzene ring) together with LiBF₄ as additives to the nonaqueous electrolyte x1, exhibited improvement in capacity retention percentage after 20 days of storage at the elevated temperature (60° C.) as a result of adjustment of the level of addition of LiBF₄. In these cases, likewise, the batteries C2 to C7 in which the level of addition of LiBF₄ was not lower than 0.05% by mass but not higher than 0.50% by mass exhibited improvement in capacity retention percentage after 20 days of storage at the elevated temperature (60° C.) while the improvement in capacity retention percentage of the batteries C4 and C5 in which the level of addition of LiBF₄ was not less than 0.10% by mass but not higher than 0.20% by mass, was even more remarkable.

Further, the batteries D1-D9 using nonaqueous electrolytes which were prepared with the addition of 2.00% by mass of VC, 1.00% by mass of CHB (a cycloalkylbenzene derivative) and 1.50% by mass of tert-amylbenzene (TAB) (an alkylbenzene derivative having a quaternary carbon atom directly bound to the benzene ring and having no primary or secondary alkyl group directly bound to the benzene ring) together with LiBF₄ as additives to the nonaqueous electrolyte x1, exhibited improvement in capacity retention percentage after 20 days of storage at the elevated temperature (60° C.) as a result of adjustment of the level of addition of LiBF₄. In these cases, too, the batteries D2 to D7 in which the level of addition of LiBF₄ was not lower than 0.05% by mass but not higher than 0.50% by mass showed improvement in capacity retention percentage after 20 days of storage at the elevated temperature (60° C.) while the improvement in capacity retention percentage of the batteries D4 and D5 in which the level of addition of LiBF₄ was not less than 0.10% by mass but not higher than 0.20% by mass was more remarkable.

This is presumably because the inclusion of additives such as cyclohexylbenzene (CHB) as a cycloalkylbenzene derivative, and/or tert-amylbenzene (TAB) or tert-butylbenzene (TBB) as an alkylbenzene derivative having a quaternary carbon atom directly bound to the benzene ring and having no primary or secondary alkyl group directly bound to the benzene ring together with LiBF₄ and VC, results in modification of the characteristics of the film coating formed on the positive electrode surface, thereby preventing the positive electrode active material from reacting with the nonaqueous electrolyte even during storage at elevated temperatures.

6. Levels of Addition of the Additives

Investigations were then conducted regarding the levels of addition of cyclohexylbenzene (CHB) as a cycloalkylbenzene derivative, of tert-amylbenzene (TAB) or tert-butylbenzene (TBB) as an alkylbenzene derivative having a quaternary carbon atom directly bound to the benzene ring and having no primary or secondary alkyl group directly bound to the benzene ring and of vinylene carbonate (VC).

(1) Investigation as to the Level of Addition of cyclohexylbenzene (CHB)

Nonaqueous electrolytes i0-i6 were respectively prepared by adding 2.00% by mass of VC and 0.30% by mass of LiBF₄ to the above-mentioned nonaqueous electrolyte x1, together with cyclohexylbenzene (CHB), as additives. Those containing 0.50% by mass, 1.00% by mass, 2.00% by mass, 3.00% by mass, 4.00% by mass, and 5.00% by mass of CHB based on the mass of the nonaqueous electrolyte were designated as nonaqueous electrolytes i1, i2, i3, i4, i5, and i6, respectively. The CHB-free nonaqueous electrolyte was designated as nonaqueous electrolyte i0.

Then, using these nonaqueous electrolytes i0-i6, nonaqueous electrolyte batteries 10 (I0-I6) with a design capacity of 700 mAh were constructed in the same manner as mentioned above. The manufactured nonaqueous electrolyte battery using the nonaqueous electrolyte i0 was designated battery I0, and those batteries using the nonaqueous electrolytes i1, i2, i3, i4, i5 and i6 were designated nonaqueous electrolyte batteries I1, I2, I3, I4, I5 and I6, respectively. The batteries I0-I6 were then subjected to similar tests in the manner described above, and their respective initial capacity ratios and the capacity retention percentages after 20 days of storage at an elevated temperature (60° C.) were determined. The results obtained are shown in Table 3 below.

TABLE 3

| | | | | | | | Capacity |
|---|---|---|---|---|---|---|---|
| | Additives and Levels of | | | | | Relative | Retention |
| | Addition (% by mass) | | | | | Initial | (%) at high |
| Battery | LiBF₄ | VC | CHB | TAB | TBB | Capacity | temperature |
| I0 | 0.30 | 2.00 | 0 | 0 | 0 | 100 | 83 |
| I1 | 0.30 | 2.00 | 0.50 | 0 | 0 | 99 | 90 |
| I2 | 0.30 | 2.00 | 1.00 | 0 | 0 | 100 | 91 |
| I3 | 0.30 | 2.00 | 2.00 | 0 | 0 | 100 | 92 |
| I4 | 0.30 | 2.00 | 3.00 | 0 | 0 | 101 | 90 |
| I5 | 0.30 | 2.00 | 4.00 | 0 | 0 | 100 | 87 |
| I6 | 0.30 | 2.00 | 5.00 | 0 | 0 | 100 | 81 |

As may be gathered from Table 3, the batteries I1-I4 in which the level of addition of cyclohexylbenzene (CHB) was not less than 0.50% by mass but not higher than 3.00% by mass on the nonaqueous electrolyte mass basis exhibited improvement in capacity retention percentage after 20 days of storage at the elevated temperature (60° C.) (high temperature capacity retention percentage). These results indicate that cyclohexylbenzene (CHB) should be added preferably together with vinylene carbonate (VC) and LiBF₄, as an additive to the nonaqueous electrolyte x1 in an amount not less than 0.50% by mass but not more than 3.00% by mass relative to the mass of the nonaqueous electrolyte.

(2) Investigation as to the Level of Addition of tert-amylbenzene (TAB)

Nonaqueous electrolytes j0-j6 were respectively prepared by adding 2.00% by mass of VC and 0.30% by mass of LiBF₄ to the above-mentioned nonaqueous electrolyte x1 together with tert-amylbenzene (TAB), as additives. The nonaqueous electrolytes containing 0.50% by mass, 1.00% by mass, 2.00% by mass, 3.00% by mass, 4.00% by mass, and 5.00% by mass of TAB based on the mass of the nonaqueous electrolyte, were designated as nonaqueous electrolytes j1, j2, j3, j4, j5, and j6, respectively. The TAB-free nonaqueous electrolyte was designated as nonaqueous electrolyte j0.

Then, using these nonaqueous electrolytes j0-6, nonaqueous electrolyte batteries 10 (J0-J6) with a design capacity of 700 mAh were constructed in the same manner as mentioned above. The nonaqueous electrolyte battery using the nonaqueous electrolyte j0 was designated as battery J0, and the manufactured nonaqueous electrolyte batteries using nonaqueous electrolytes j1, j2, j3, j4, j5 and j6 were designated as nonaqueous electrolyte batteries J1, J2, J3, J4, J5 and J6, respectively. The batteries J0-J6, were then subjected to the same tests mentioned above, and their respective initial capacity ratios and the capacity retention percentages after 20 days of storage at an elevated temperature (60° C.) were determined. The results obtained are shown in Table 4 below.

TABLE 4

| | | | | | | | Capacity |
|---|---|---|---|---|---|---|---|
| | Additives and Levels of | | | | | Relative | Retention |
| | Addition (% by mass) | | | | | Initial | (%) at high |
| Battery | LiBF₄ | VC | CHB | TAB | TBB | Capacity | temperature |
| J0 | 0.30 | 2.00 | 0 | 0 | 0 | 100 | 83 |
| J1 | 0.30 | 2.00 | 0 | 0.50 | 0 | 101 | 91 |
| J2 | 0.30 | 2.00 | 0 | 1.00 | 0 | 101 | 91 |
| J3 | 0.30 | 2.00 | 0 | 2.00 | 0 | 100 | 92 |
| J4 | 0.30 | 2.00 | 0 | 3.00 | 0 | 99 | 91 |
| J5 | 0.30 | 2.00 | 0 | 4.00 | 0 | 100 | 85 |
| J6 | 0.30 | 2.00 | 0 | 5.00 | 0 | 100 | 81 |

As may be gleaned from Table 4, the batteries J1-J4 in which the level of addition of tert-amylbenzene (TAB) was not less than 0.50% by mass but not higher than 3.00% by mass on the nonaqueous electrolyte mass basis showed marked improvement in capacity retention percentage after 20 days of storage at the elevated temperature (60° C.) (high temperature capacity retention percentage). These results indicate that tert-amylbenzene (TAB) should be added preferably together with vinylene carbonate (VC) and LiBF₄ as an additive to the nonaqueous electrolyte x1 in an amount not less than 0.50% by mass but not more than 3.00% by mass relative to the mass of the nonaqueous electrolyte.

(3) Investigation as to the Level of Addition of tert-butylbenzene (TBB)

Nonaqueous electrolytes k0-k6 were then respectively prepared by adding 2.00% by mass of VC and 0.30% by mass of LiBF₄ to the above-mentioned nonaqueous electrolyte x1, together with tert-butylbenzene (TBB), as additives. Those containing 0.50% by mass, 1.00% by mass, 2.00% by mass, 3.00% by mass, 4.00% by mass, and 5.00% by mass of TBB, based on the mass of the nonaqueous electrolyte, were designated as nonaqueous electrolytes k1, k2, k3, k4, k5, and k6, respectively. The TBB-free nonaqueous electrolyte was designated as nonaqueous electrolyte k0.

Then, using these nonaqueous electrolytes k0-k6, nonaqueous electrolyte batteries 10 (K0-K6) with a design capacity of 700 mAh were constructed in the same manner as mentioned above. The nonaqueous electrolyte battery using the nonaqueous electrolyte k0 was designated as battery K0, and the manufactured nonaqueous electrolyte batteries using the nonaqueous electrolytes k1, k2, k3, k4, k5 and k6 were designated as nonaqueous electrolyte batteries K1, K2, K3, K4, K5 and K6, respectively. The batteries K0-K6, were then subjected to the same tests mentioned above, and their respective initial capacity ratios and the capacity retention percentages after 20 days of storage at an elevated temperature (60° C.) were determined. The results obtained are shown in Table 5 below.

TABLE 5

| | | | | | | | Capacity |
|---|---|---|---|---|---|---|---|
| | Additives and Levels of | | | | | Relative | Retention |
| | Addition (% by mass) | | | | | Initial | (%) at high |
| Battery | LiBF₄ | VC | CHB | TAB | TBB | Capacity | temperature |
| K0 | 0.30 | 2.00 | 0 | 0 | 0 | 100 | 83 |
| K1 | 0.30 | 2.00 | 0 | 0 | 0.50 | 100 | 91 |
| K2 | 0.30 | 2.00 | 0 | 0 | 1.00 | 100 | 91 |
| K3 | 0.30 | 2.00 | 0 | 0 | 2.00 | 99 | 92 |
| K4 | 0.30 | 2.00 | 0 | 0 | 3.00 | 100 | 91 |
| K5 | 0.30 | 2.00 | 0 | 0 | 4.00 | 101 | 82 |
| K6 | 0.30 | 2.00 | 0 | 0 | 5.00 | 100 | 80 |

As may be derived from Table 5, the batteries K1-K4 in which the level of addition of tert-butylbenzene (TBB) was not less than 0.50% by mass but not more than 3.00% by mass on the nonaqueous electrolyte mass basis showed remarkable improvement in capacity retention percentage after 20 days of storage at the elevated temperature (60° C.) (high temperature capacity retention percentage). These results indicate that tert-butylbenzene (TBB) should be added preferably together with vinylene carbonate (VC) and LiBF₄ as an additive to the nonaqueous electrolyte x1 in an amount not less than 0.50% by mass but not more than 3.00% by mass relative to the mass of the nonaqueous electrolyte.

(4) Investigation as to the Level of Addition of vinylene carbonate (VC)

Nonaqueous electrolytes l0-l6 were respectively prepared by adding 2.00% by mass of CHB and 0.30% by mass of LiBF₄ to the above-mentioned nonaqueous electrolyte x1, together with vinylene carbonate (VC), as additives. Those containing 0.50% by mass, 1.00% by mass, 2.00% by mass, 3.00% by mass, 4.00% by mass, and 5.00% by mass of VC based on the mass of the nonaqueous electrolyte, were designated as nonaqueous electrolytes l1, l2, l3, l4, l5, and l6, respectively. The VC-free nonaqueous electrolyte was designated as nonaqueous electrolyte l0.

Then, using these nonaqueous electrolytes l0-l6, nonaqueous electrolyte batteries 10 (L0-L6) with a design capacity of 700 mAh were constructed in the same manner as mentioned above. The nonaqueous electrolyte battery using the nonaqueous electrolyte l0 was designated as battery L0, and those manufactured nonaqueous electrolyte batteries using the nonaqueous electrolytes l1, l2, l3, l4, l5 and l6 were designated as nonaqueous electrolyte batteries L1, L2, L3, L4, L5 and L6, respectively. The batteries L0-L6, were then subjected to the same tests mentioned above, and their respective initial capacity ratios and the capacity retention percentages after 20 days of storage at an elevated temperature (60° C.) were determined. The results obtained are shown in Table 6 below.

TABLE 6

| | | | | | | | Capacity |
|---|---|---|---|---|---|---|---|
| | Additives and Levels of | | | | | Relative | Retention |
| | Addition (% by mass) | | | | | Initial | (%) at high |
| Battery | LiBF₄ | VC | CHB | TAB | TBB | Capacity | temperature |
| L0 | 0.30 | 0 | 1.00 | 0 | 0 | 100 | 82 |
| L1 | 0.30 | 0.50 | 1.00 | 0 | 0 | 100 | 85 |
| L2 | 0.30 | 1.00 | 1.00 | 0 | 0 | 100 | 91 |
| L3 | 0.30 | 2.00 | 1.00 | 0 | 0 | 100 | 91 |
| L4 | 0.30 | 3.00 | 1.00 | 0 | 0 | 100 | 90 |
| L5 | 0.30 | 4.00 | 1.00 | 0 | 0 | 98 | 82 |
| L6 | 0.30 | 5.00 | 1.00 | 0 | 0 | 96 | 80 |

As may be gathered from Table 6, the batteries L2-L4 in which the level of addition of vinylene carbonate (VC) was not less than 1.00% by mass but not more than 3.00% by mass on the nonaqueous electrolyte mass basis also showed remarkable improvement in capacity retention percentage after 20 days of storage at the elevated temperature (60° C.) (high temperature capacity retention percentage). These results indicate that vinylene carbonate (VC) should be added preferably together with cyclohexylbenzene (CHB) and LiBF₄, as an additive to the nonaqueous electrolyte x1 in an amount of not less than 1.00% by mass but not more than 3.00% by mass relative to the mass of the nonaqueous electrolyte.

7. Investigation Conducted on the Positive Electrode Active Material

In the numerous investigations referred to in the above, lithium cobalt oxide (LiCoO₂) was used as positive electrode active material in the manufactured nonaqueous electrolyte batteries. The following describes the results of investigations conducted using material other than lithium cobalt oxide (LiCoO₂) as positive electrode active material. Thus, positive electrodes were produced using positive electrode active material prepared by mixing lithium cobalt oxide (LiCoO₂) with spinel type lithium manganese oxide (LiMn₂O₄) in a mass ratio of 1:1, and nonaqueous electrolyte batteries M1 and X2 with a design capacity of 700 mAh were thereafter manufactured in the same manner as mentioned above.

A non-aqueous electrolyte battery was manufactured by using the nonaqueous electrolyte a6 (resulting from the addition of 0.30% by mass of LiBF₄, 2.00% by mass of VC and 1.00% by mass of CHB to the nonaqueous electrolyte x1as additives) and designated as nonaqueous electrolyte battery M1. Another non-aqueous electrolyte battery was manufactured by using the additive-free nonaqueous electrolyte x1 and designated as nonaqueous electrolyte battery X2. Similar tests were then conducted on these batteries M1 and X2 in the manner mentioned above, and their respective initial capacity ratios and the capacity retention percentages after 20 days of storage at an elevated temperature (60° C.) were determined. The results obtained are shown in Table 7 below, together with the corresponding results obtained with respect to the above-mentioned batteries A6 and X1 for comparative purposes.

TABLE 7

| | Positive electrode | | | | | |
|---|---|---|---|---|---|---|
| | active material | | Additives and | | | Capacity |
| | mixing | | Levels of Addition | | | Retention (%) |
| | ratio (% by mass) | | (% by mass) | | | at high |
| Battery | LiCoO₂ | LiMn₂O₄ | LiBF₄ | VC | CHB | temperature |
| X1 | 100 | 0 | 0 | 0 | 0 | 82 |
| A6 | 100 | 0 | 0.30 | 2.00 | 2.00 | 91 |
| X2 | 50 | 50 | 0 | 0 | 0 | 60 |
| M1 | 50 | 50 | 0.30 | 2.00 | 2.00 | 91 |

It may be seen from Table 7 above that when the batteries X1 and A6 in which lithium cobalt oxide (LiCoO₂) was used as positive electrode active material are compared with each other, the battery A6 using nonaqueous electrolyte a6 prepared by adding 0.30% by mass of LiBF₄, 2.00% by mass of VC and 1.00% by mass of CHB as additives showed a 9% improvement in capacity retention percentage at high temperature compared with the battery X1 in which the additive-free nonaqueous electrolyte x1 was used.

On the other hand, when the batteries X2 and M1 in which lithium cobalt oxide (LiCoO₂) and spinel type lithium manganese oxide (LiMn₂O₄) were used as positive electrode active materials were compared with each other, the battery M1 using nonaqueous electrolyte a6 prepared by adding 0.30% by mass of LiBF₄, 2.00% by mass of VC and 1.00% by mass of CHB as additives showed an improvement of as much as 31% capacity retention percentage at high temperature compared with the battery X2 in which the additive-free nonaqueous electrolyte x1 was used.

It can therefore be derived from these results that when nonaqueous electrolytes containing LiBF₄ and VC as additives and further containing at least one additive selected from among CHB, TAB and TBB, the concurrent use of positive electrode active material comprising a mixture of lithium cobalt oxide (LiCoO₂) and spinel type lithium manganese oxide (LiMn₂O₄) as additives is preferable.

While cyclohexylbenzene (CHB) was used as an example of a cycloalkylbenzene derivative in the above-mentioned embodiments, similar results can also be expected from the use of cyclopentylbenzene (CPB) in lieu of cyclohexylbenzene (CHB). Similarly, while tert-amylbenzene or tert-butylbenzene was used as alkyl benzene derivative having a quaternary carbon atom directly bound to the benzene ring and having no primary or secondary alkyl group directly bound to the benzene ring, similar results can be expected from the use of tert-hexylbenzene as well.

1. A nonaqueous electrolyte battery comprising a positive electrode for occluding and releasing lithium ions, a negative electrode for occluding and releasing lithium ions, a separator separating the positive electrode and negative electrode from each other, and a nonaqueous electrolyte produced from the dissolution of a solute comprising a lithium salt in a nonaqueous solvent, characterized in that the said nonaqueous electrolyte comprises vinylene carbonate (VC) and lithium borofluoride (LiBF₄) as well as at least one derivative selected from among cycloalkylbenzene derivatives or from among alkylbenzene derivatives having a quaternary carbon atom directly bound to the benzene ring and having no primary or secondary alkyl group directly bound to the benzene ring.

2. A nonaqueous electrolyte battery as claimed in claim 1, wherein the said cycloalkylbenzene derivative is cyclohexylbenzene or cyclopentylbenzene.

3. A nonaqueous electrolyte battery as claimed in claim 1, wherein the said alkylbenzene derivative having a quaternary carbon atom directly bound to the benzene ring and having no primary or secondary alkyl group directly bound to the benzene ring is tert-amylbenzene, tert-butylbenzene or tert-hexylbenzene.

4. A nonaqueous electrolyte battery as claimed in claim 1, wherein the said positive electrode comprises a mixed positive electrode active material composed of lithium cobalt oxide and spinel type lithium manganese oxide.

5. A nonaqueous electrolyte battery comprising a positive electrode for occluding and releasing lithium ions, a negative electrode for occluding and releasing lithium ions, a separator separating the positive electrode and negative electrode from each other, and a nonaqueous electrolyte produced from the dissolution of a solute comprising a lithium salt in a nonaqueous solvent, characterized in that the said nonaqueous electrolyte comprises vinylene carbonate (VC) and lithium borofluoride (LiBF₄) as well as at least one derivative selected from among cycloalkylbenzene derivatives or from among alkylbenzene derivatives having a quaternary carbon atom directly bound to the benzene ring and having no primary or secondary alkyl group directly bound to the benzene ring,
the content of the said vinylene carbonate (VC) being not lower than 1% by mass but not higher than 3% by mass relative to the mass of the said nonaqueous electrolyte,
the content of the said lithium borofluoride (LiBF₄) being not lower than 0.05% by mass but not higher than 0.5% by mass relative to the mass of the said nonaqueous electrolyte, and
the content of the said derivative being not lower than 0.5% by mass but not higher than 3% by mass relative to the mass of the said nonaqueous electrolyte.

6. A nonaqueous electrolyte battery as claimed in claim 5, wherein the content of lithium borofluoride (LiBF₄) is not lower than 0.1% by mass but not higher than 0.2% by mass relative to the mass of said nonaqueous electrolyte.

7. A nonaqueous electrolyte battery as claimed in claim 5, wherein the said cycloalkylbenzene derivative is cyclohexylbenzene or cyclopentylbenzene.

8. A nonaqueous electrolyte battery as claimed in claim 5, wherein the said alkylbenzene derivative having a quaternary carbon atom directly bound to the benzene ring and having no primary or secondary alkyl group directly bound to the benzene ring is tert-amylbenzene, tert-butylbenzene or tert-hexylbenzene.

9. A nonaqueous electrolyte battery as claimed in claim 5, wherein the said positive electrode comprises a mixed positive electrode active material composed of lithium cobalt oxide and spinel type lithium manganese oxide.
